(19) United States
(12) Patent Application Publication
(10) Pub. No.: US 2013/0170576 A1
(43) Pub. Date: Jul. 4, 2013

(54) Assembly and Method for Detecting Multiple Level Signals

(71) Applicant: John Qingchong Liu, Rochester Hills, MI (US)

(72) Inventor: John Qingchong Liu, Rochester Hills, MI (US)

(21) Appl. No.: 13/341,848

(22) Filed: Dec. 30, 2011

(51) Int. Cl. H04L 27/06; H04L 27/00

(52) U.S. Cl. 375/295; 375/340

(57) ABSTRACT

Multiple level signals are constructed from more than one level of component sequences each having correlation properties. A receiver receives the multiple level signal. A signal detector in the receiver performs correlation or matched filtering to the received signal. When a signal is detected, the signal detector triggers a timing estimator, a phase estimator, and a frequency estimator. The timing estimator employs an output signal from the signal detector, performs interpolation and timing estimation. The timing estimate adjusts a sampling clock for time synchronization. The phase estimator employs output signals from the correlation devices to estimate phase. The phase estimate is employed to achieve phase synchronization. The received signal is converted to an equivalent continuous wave signal by the frequency estimator. The frequency estimator performs discrete Fourier transform to the continuous wave signal, and estimates frequency offset. The frequency offset estimate is employed to achieve frequency synchronization.

### BACKGROUND OF THE INVENTION

1. Field of the Invention

The invention relates to a device and method to generate a signal, transmit the signal, and detect the signal in communication systems.

2. Description of the Related Art

Signal detection is an essential task in communication systems. Usually a preamble signal is transmitted at the beginning of a message for signal detection and parameter estimation. The preamble signal is also known as unique word. Design of preamble signals is equivalent to design sequences. The preamble signal is preferred to have favorable correlation properties, good family size, and high linear complexity. The same preamble signal is stored in a receiver. The receiver takes an input signal, performs correlation with the pre-stored preamble signal, and compares the correlation against a threshold. If the correlation is not below the threshold, the receiver declares that the signal is detected, and uses the received signal and the correlation for parameter estimation, including timing, phase and frequency.

Traditionally, the receiver has to compute the full correlation of the received signal with the entire preamble signal. An example is to transmit a maximal length sequence, and detect it by computing sample by sample a full correlation of the received signal with the pre-stored signal. Consequently, the complexity of signal detection is high. In traditional broadband communication terminals, the signal detector has to compute a significant amount of multiplications, which always claims a large portion of the receiver hardware, and is an expensive module in the receiver. Some signal detection demands too many multiplications to be supported by even the fastest hardware available on the market.

New signals with favorable features for detection must be designed to minimize signal detection complexity and reduce signal detector cost, while maintaining the same detection performance compared with traditional signal design and detection methods.

In 1968, Turyn very briefly introduced the tensor product of two sequences as a way of shifting the definition of sequences to a different group. The tensor product is also known as the Kronecker product of two sequences or simply a Kronecker sequence. Turyn did not give any hardware design to work with the Kronecker sequence.

In 1991, Karkkainen and Leppanen compared the performance of asynchronous CDMA systems using Kronecker sequences against the performance of communication systems using conventional sequences such as Gold, Kasami and maximal length sequences. They considered applying the Kronecker product to two component sequences, including: a Barker sequence with length 11 and M-sequence with length 127; a Gold sequence with length 31 and Gold sequence with length 63; a Barker sequence with length 11 and Gold sequence with length 127; and a Barker sequence with length 11 and a small Kasami sequence of length 63. The receiver first correlates the received signal to find the right phase of the first sequence. After detection and synchronization is achieved for the first sequence, the inner sequence (the first sequence) will be locked to the received signal, and then the second correlator will begin to search for the right phase of the outer sequence (the second sequence). The success of such an acquisition scheme for Kronecker sequences depends upon the receiver input SNR being large enough at E_{b}/N₀≦15 dB to permit reliable detection of the in-phase peak in the auto-correlation for the first component sequence (the inner sequence). This design requires the length of the first sequence to be large, the system SNR to be high, and the length of the second sequence to be short. Authors have stated that the choice of the inner component sequence seems not to be so critical, and that the outer component sequence (the second sequence) must be considerably shorter than the inner sequence. The Barker sequence as an outer sequence is a very good choice. However, the Barker sequences are not recommended for the inner sequence. The study showed that Kronecker sequences cause 0.5 dB to 1.0 dB degradation in SNR at E_{b}/N₀=15 dB in asynchronous CDMA systems. Such a loss is considered large in communication systems.

In 1997, Elders-Boll et al. investigated the sequence acquisition in communication systems with sequences constructed using the Turyn method. It was shown that the sequences constructed using the Turyn method gave 50% reduction in the sequence acquisition time compared with the maximal length sequences of the same length. However, the acquisition considered only the inner sequence, not the outer sequence, and gave a very large performance loss.

In 1999, Liu gave an example of a 3-level sequence. Liu independently proposed to detect the 3-level sequence employing three correlators and three signal detectors for every level of signal, respectively. The strength of Liu's method is the reduction of the hardware complexity of signal detector. Its weakness was that it required signal detection to be performed at every level, because if the signal detector at any level i=3 misses a component signal, then the entire signal is not detected.

In summary, previous methods of signal design and detection have employed correlation of the entire signal where the correlation is computed sample-by-sample for the received signal and the prestored entire signal. They follow the traditional theory and practice that correlation must be computed sample-by-sample for the whole signal. In designing Kronecker sequences, prior work considered only two component sequences. In detecting Kronecker sequences, the prior art emphasized detection only of the inner component sequence. If the inner component sequence is not detected, then the prior art definitely fails. Because the inner sequence contains only a fraction of the energy of the entire Kronecker sequence, the prior art has a high probability of missing the Kronecker sequence in the detection stage.

### SUMMARY OF THE INVENTION

A signal detector for detecting a received signal includes an in-phase input port for receiving an in-phase received signal and a quadrature input port for receiving a quadrature received signal. An in-phase correlation device is electrically connected to the in-phase input port and a quadrature correlation device is electrically connected to the quadrature input port. A memory device is electrically connected to the in-phase and quadrature correlation devices. The memory device stores a key to be supplied to both the in-phase and quadrature correlation devices as an operand to the in-phase and quadrature received signals. The correlation creates an in-phase correlation signal and a quadrature correlation signal, respectively. An in-phase squaring device squares the in-phase correlation signal to generate an in-phase squared signal. A quadrature squaring device squares the quadrature correlation signal to generate a quadrature squared signal. An adder adds the in-phase squared signal and the quadrature squared signal to create an added signal. A comparator to compare the added signal against a threshold to determine whether the received signal is a communication signal.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a block diagram of one embodiment of a communication system in accordance with the invention;

FIGS. 2A and 2B are block diagrams of first and second embodiments of a signal generator for the invention, respectively;

FIG. 3 is a block diagram of the transmitter for the invention;

FIG. 4 is a block diagram of the receiver for the invention;

FIG. 5 is a block diagram of a first embodiment of a signal detector for the invention;

FIG. 6 is a block diagram of a second embodiment of the signal detector for the invention; and

FIG. 7 is a block diagram of a third embodiment of the signal detector for the invention.

### DETAILED DESCRIPTION OF THE INVENTION

Signal Generation

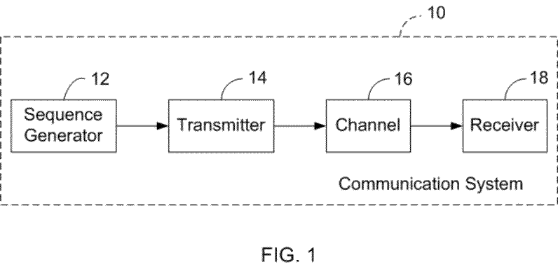

Referring to FIG. 1, a communication system 10 in accordance with one embodiment of the present invention is illustrated. The system 10 includes a sequence generator 12, a transmitter 14, a channel 16 and a receiver 18. The transmitter 14 transmits signals to the receiver 18 through the channel 16, which may be any known media for transmitting an electromagnetic signal. The sequence generator 12 generates a signal to be transmitted through the channel 16 by the transmitter 14 and received by the receiver 18, which may employ the use of an antenna, signal amplifier or other such device as is known in the art.

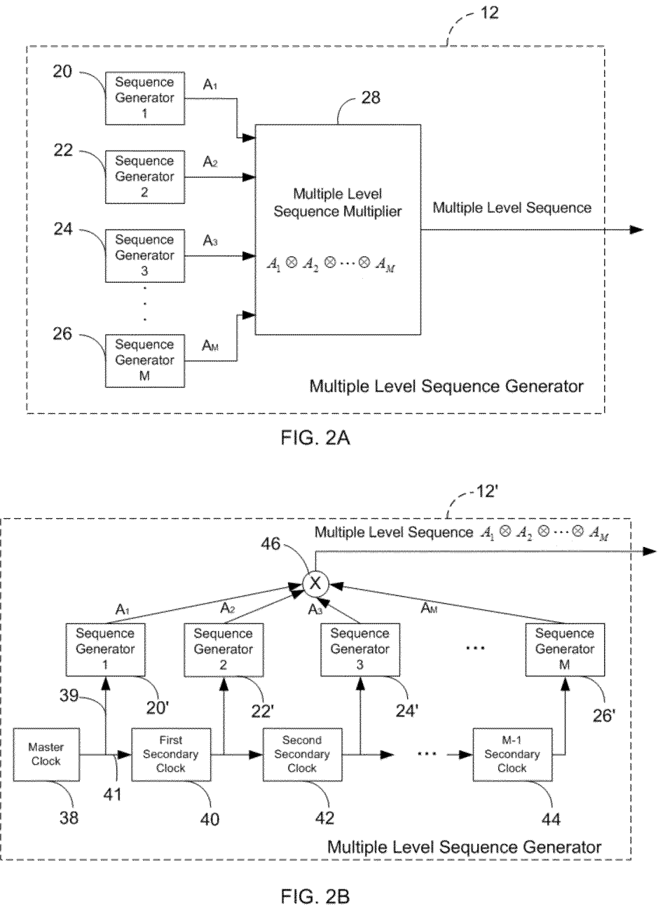

FIG. 2A shows a first structure of a multiple level sequence generator 12. In this first structure 12, a sequence generator 20 produces the first component sequence A₁, a sequence generator 22 generates the second component sequence A₂, a sequence generator 24 provides the third component sequence A₃, and a sequence generator 26 provides the Mth component sequence A_{M}. A multiple level sequence multiplier 28 takes the component sequences A₁, A₂, . . . , A_{M} as input signals and generates a multiple level sequence A₁ [symbol] A₂ [symbol] . . . [symbol] A_{M} to be hereinafter defined. When the length of the sequence generator 12 output signal is large, it is necessary to implement the multiple level sequence generator 12 in hardware for fast signal generation.

In FIG. 2B, wherein like primed reference numerals represent similar elements of that which is shown in FIG. 2A, a second structure 12′ consists of a sequence generator 20′ for A₁, a sequence generator 22′ for A₂, a sequence generator 24′ for A₃, a sequence generator 26′ for A_{M}, and a master clock 38 to operate the sequence generator 20′ by generating a clock signal through a connection 39. The clock signal is also transmitted via a connection 41 to a first secondary clock 40. The first secondary clock 40 is a divide-by-L₁ circuit with L₁ being the length of A₁ to operate the sequence generator 22′. A second secondary clock 42 is a divide-by-L₂ circuit with L₂ the length of A₂ to operate the sequence generator 24′. The second secondary clock 42 is driven by the first secondary clock 40. Likewise, an M−1 secondary clock 44 is a divide-by-L_{M-1} circuit with L_{M-1} the length of A_{M-1} to operate the sequence generator 26′. A multiplier 46 takes A₁, A₂, . . . , A_{M} as input signals and generates multiple level sequences A₁ [symbol] A₂ [symbol] . . . [symbol] A_{M}. Therefore, each clock output, including the master clock 38, is sent in parallel to a sequence generator and the next secondary clock in line associated with the next sequence generator. If one were to ignore the connections between the clocks and the sequence generators, it could be said the master clock 38 and the secondary clocks 40, 42, 44 are connected in series, with the Mth secondary clock being driven by the (M−1)th secondary clock (and with the first secondary clock being driven by the master clock).

In the area of telecommunications, signal design is also called sequence design. In a communication system, a signal for detection and estimation is generated through filtering a sequence with a pulse shaping function. The signal can be written as a convolution of the sequence with the pulse shaping function. The correlation function of the signal is determined by the correlation function of the sequence and the pulse shaping function. Because the pulse shaping function is deterministic, designing a signal is equivalent to designing a sequence.

A multiple level sequence of M≧2 levels can be constructed by applying the Kronecker product to M component sequences. We use the Kronecker product to define multiple level sequences. The construction of multiple level sequences is a generalization of the prior work by the inventor. Methods to detect multiple level signals are provided below.

Let A=(aᵢⱼ) be an m×k matrix and B=(bᵢⱼ) an n×1 matrix. The Kronecker product of A and B is denoted by A [symbol] B and defined as follows:

$$A ⊗ B = ( \begin{matrix}{b}_{11} A & {b}_{12} A & … & {b}_{1 l} A \\ {b}_{21} A & {b}_{22} A & … & {b}_{2 l} A \\ … & … & … & … \\ {b}_{n 1} A & {b}_{n 2} A & … & {b}_{nl} A\end{matrix} ) \qquad ( 1 )$$

A two level sequence is a Kronecker product of two sequences.

Let A={aᵢ}ᵢ₋₁^{m} and B={bᵢ}ᵢ₌₁ⁿ be two sequences viewed as two vectors with dimension 1×m and 1×n, respectively. Then A [symbol] B is called a multiple level sequence with 2 levels, or a 2-level sequence. A={aᵢ}ᵢ₋₁^{m} is called the seed sequence and B={bᵢ}ᵢ₋₁ⁿ is the mapping sequence.

One has

{aᵢ}ᵢ₋₁^{m} [symbol] {bᵢ}ᵢ₋₁ⁿ=(a₁b₁, a₂b₁, . . . aₘb₁, a₁b₂, a₂b₂, . . . , aₘb₂, . . . , a₁bₙ₋₁, a₂bₙ₋₁, . . . , aₘbₙ₋₁, a₁bₙ, a₂bₙ, . . . , aₘbₙ) (2)

The following associate property of the Kronecker product operator is needed to define multiple level sequence with M>2 levels.

Let A=(aᵢⱼ) be an m₁×n₁ matrix, B=(bᵢⱼ) an m₁×n₂ matrix, and C=(cᵢⱼ) an m₃×n₃ matrix. Then, (A [symbol] B) [symbol] C=A [symbol] (B [symbol] C).

We define a multiple level sequence with two or more levels.

Let Aᵢ={aᵢⱼ}ⱼ₋₁^{L}^{ᵢ} with 1≦i≦M be M sequences. The product is shown below in the equation:

$${\prod }_{i = 1}^{M} {A}_{i} = {A}_{1} ⊗ {A}_{2} ⊗ … ⊗ {A}_{M} \qquad ( 3 )$$

wherein A₁ [symbol] A₂ [symbol] . . . [symbol] A_{M} is called multiple level sequence with M levels and length

$$L = {\prod }_{i = 1}^{M} {L}_{i} .$$

The sequences Aᵢ with 1≦i≦M are called component sequences. If a multiple level sequence is to be employed for signal detection, the lengths of component sequences are recommended to be non-decreasing, i.e.,

L₁≦L₂ . . . L_{M}. (4)

An exception can occur when the auto-correlation sidelobe of a sequence with length Lᵢ is lower than the auto-correlation sidelobe of another sequence with length Lⱼ>Lᵢ. When a multiple level sequence is employed for applications other than signal detection, there is no need to follow Eq. (4).

The construction of multiple level sequences is defined on M groups. One can view any partial product

$${\prod }_{i = 1}^{l} {A}_{i}$$

with 1≦l<M as a seed sequence and the remaining

$${\prod }_{i = l + 1}^{M} {A}_{i}$$

as a mapping sequence.

Turyn's tensor product sequence or Kronecker sequence was a 2-level sequence. Prior studies considered only 2-level sequences. They all are special cases of the multiple level sequences in the current invention. Multiple level sequences are ideal for signal detection. They are also good for many other applications.

Defined on M groups, the multiple level sequences are very rich. A full list of multiple level sequences can easily take hundreds of pages. Some examples are provided to illustrate the construction.

The following definition follows Golay's definition on skew-symmetric sequences.

Let {aᵢ}ᵢ₋₁^{m} be a sequence of odd length m=2n+1. The sequence {aᵢ}ᵢ₌₁^{m} is called skew symmetric, if

aₙ₊ᵢ=(−1)ⁱaₙ₋ᵢ for any i, wherein 0≦i≦n−1. (5)

A fact about the skew symmetric sequences is that their aperiodic autocorrelation values vanish with odd shifts. For a skew symmetric sequence {aᵢ}ᵢ₌₁^{m} with length m=2n+1, its aperiodic autocorrelation with odd shift is 0.

Continuing with the Golay definition given above, a design example is provided.

### Example 1

In a broadband communications network, it is required to construct a family of sequences of length 108 and having a family size 16 for detection. Here, we use the concept of 2-level sequences to find a family of 16 sequences with small cross-correlation values.

There exists a family of skew symmetric sequences serving as the mapping sequence family with the following parameters: The maximum absolute value of the out-phase aperiodic autocorrelation function is 3, and the maximum absolute value of the cross-correlation function is 5. With these parameters, a family of 4 sequences are found as mapping sequences:

(1, 1, 1, 1, −1, −1, 1, −1, 1)

(−1, 1, 1, 1,−1,−1, 1, −1, −1)

(−1, 1, −1, 1, 1, −1, −1, −1, −1)

(−1, 1, −1, −1, 1, 1, −1, −1, −1)

The family of seed sequences can be constructed as:

(1, 1, 1, −1, 1, 1, −1, 1, −1, 1, 1, 1)

(1, −1, −1, −1, 1, 1, 1, 1, 1, −1, 1, −1)

(1, −1, −1, −1, −1, 1, −1, −1, 1, 1, −1, 1)

(−1, −1, 1, −1, 1, 1, 1, −1, −1, 1, 1, 1)

With these seed sequences and mapping sequences, 16 sequences with length 108 can be constructed as 2-levels sequences. ▪

Moving beyond Example 1, we recommend that skew-symmetric sequences are good candidates for seed sequences. One special family of skew-symmetric sequences that is the best for seed sequences are the Barker sequences.

A binary sequence {aᵢ}ᵢ₋^{m} is called a Barker sequence, if the absolute value of its off-peak aperiodic autocorrelation function is bounded by 1, i.e.,

|A(τ)|=∥Σᵢ₋₁^{m-τ}aᵢa_{i+Σ}*|≦1 for any ∀τε[1,m−1]. (6)

Only seven binary Barker sequences have been found, as listed in Table 1.

TABLE 1
Barker sequences.

| Length | Barker Sequence |
|---|---|
| 2 | B₂ = (1, 1) |
| 3 | B₃ = (1, 1, −1) |
| 4 | B₄ = (1, 1, 1, −1) or (1, 1, −1, 1) |
| 5 | B₅ = (1, 1, 1, −1, 1) |
| 7 | B₇ = (1, 1, 1, −1, −1, 1, −1) |
| 11 | B₁₁ = (1, 1, 1, −1, −1, −1, 1, −1, −1, 1, −1) |
| 13 | B₁₃ = (1, 1, 1, 1, 1, −1, −1, 1, 1, −1, 1, −1, 1) |

Turyn and Storer proved that there are no other odd length Barker sequences beyond length 13. It is widely believed that no other even length Barker sequences exist beyond length 4.

Barker sequences have the best overall aperiodic autocorrelation. This invention recommends Barker sequences as good candidates for both seed sequences and mapping sequences. Employing Barker sequences as both seed sequence and mapping sequence is the best choice.

For the purpose of signal detection, when the signal length L is not higher than 13, Barker sequences are the best. When the signal length is greater than 13, 2-level sequences can be constructed employing Barker sequences as seed sequence and mapping sequence. This will cover the length up to 169=13×13. Any combination B_{L}_{₁} [symbol] B_{L}_{₂} with L₁≦L₂ will have a maximum sidelobe of L₁≦\sqrt{L₁L₂} in its autocorrelation function. For example, B₁₁ [symbol] B₁₃ gives a signal of length 143, which has a maximum sidelobe of 11<\sqrt{143} in the autocorrelation function. For signal length greater than 169, one can either employ 2-level sequences, or M-level sequences with M≧3. When the signal length makes it impossible to employ Barker sequences as both seed sequence and mapping sequence, this invention recommends reserving the Barker sequence as the mapping sequence, i.e., employing Barker sequence as the component sequence A_{M} at the highest level M.

For example, a maximum length sequence M₃₁ with length 31 as the seed sequence and the Barker sequence with length 13 will give a 2-level sequence M₃₁ [symbol] B₁₃ of length 403=31×13. A three-level sequence employing the Barker sequence with length 3, the Barker sequence with length 11 and the Barker sequence with length 13 will provide a new sequence B₃ [symbol] B₁₁ [symbol] B₁₃ with length 429. The signal detection performance using B₃ [symbol] B₁₁ [symbol] B₁₃ is a little better than using the 2-level sequence, M₃₁ [symbol] B₁₃. The signal detector complexity using B₃ [symbol] B₁₁ [symbol] B₁₃ can be only 27/44=61% of the complexity using M₃₁ [symbol] B₁₃. B₇ [symbol] B₁₁ [symbol] B₁₃ gives a signal of length 1001. B₇ [symbol] B₁₁ [symbol] B₁₁ [symbol] B₁₃ is a signal of length 11011. B₇ [symbol] B₇ [symbol] B₁₁ [symbol] B₁₁ [symbol] B₁₃ [symbol] B₁₃ gives a sequence of length 1002001.

Signal Transmission

Let

$$\underline{d} = {\prod }_{i = 1}^{M} {A}_{i}$$

be a multiple level sequence for signal detection and parameter estimation. Usually a payload follows the sequence.

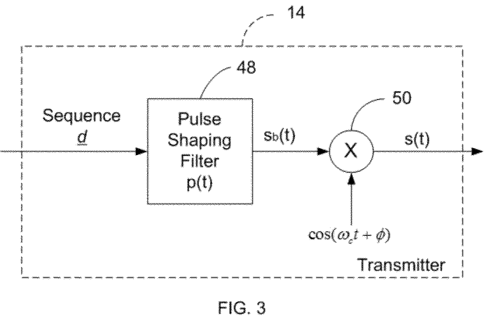

In FIG. 3, the transmitter 14 transmits a signal for detection and estimation. The transmitter 14 consists of a pulse shaping filter 48 and a mixer 50. The pulse shaping filter 48 takes the sequence d=(d₁,d₂, . . . d_{L}) as the input signal and converts it to a baseband signal

$${s}_{b} ( t ) = {\sum }_{k = 1}^{L} {d}_{k} p ( t - kT ) \qquad ( 7 )$$

where p(t) is the pulse shaping function and T the symbol time. The mixer 50 takes the baseband signal s_{b}(t) and a carrier signal cos(ω_{c}t+φ) as input signals, multiplies them to give a signal

s(t)=s_{b}(t)cos(ω_{c}t+φ) (8)

where ω_{c} is the carrier frequency and φ the carrier phase. The transmitter 14 sends this signal through the channel 16 to the receiver 18.

Signal Detection

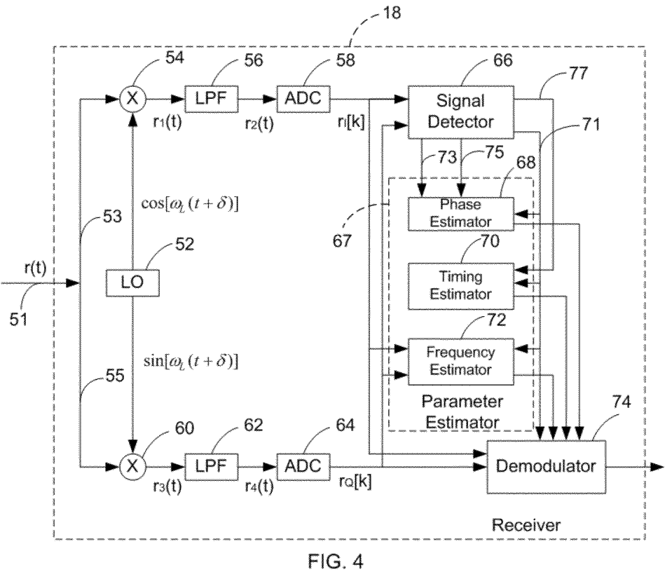

Referring to FIG. 4, the receiver 18 receives a received signal

r(t)=s(t)+n(t) (9)

through an input port 51 wherein n(t) is the additive white Gaussian noise. The input port 51 has a first branch 53 and a second branch 55. The received signal r(t) is transmitted equally along both the first 53 and second 55 branches.

A local oscillator 52 generates a cosine wave cos [ω_{L}(t+δ)] and a sine wave sin [ω_{L}(t+ε)], where ω_{L} is the frequency of the local oscillator and δ is the timing offset. Let φ_{L}=ω_{L}δ. The cosine wave signal is called an in-phase wave signal and the sine wave signal is called a quadrature wave signal. An in-phase channel mixer 54 mixes the received signal with the in-phase wave signal. The in-phase channel mixer 54 output signal is referred to as an in-phase received signal and is defined by

r₁(t)=r(t)cos(Δωt+Δφ)+n₁(t) (10)

An in-phase low pass filter 56 removes the component at ω_{c}+ω_{L} from the in-phase received signal. The output of the in-phase low pass filter 56 is in the baseband, is referred to as the in-phase low pass received signal and can be written as

r₂(t)=½s_{b}(t)cos(Δωt+Δφ)+n₁(t) (11)

where Δω=ω_{c}−ω_{L} is the frequency offset between the transmitter oscillator and the local oscillator 52 in the receiver 18, Δφ=φ−φ_{L} is the phase difference, and n₁(t) is Gaussian noise process.

An analog-to-digital converter (ADC) 58 converts the in-phase low pass received signal r₂(t) to a digital in-phase received signal r₁[k] at sampling rate Nₛ≧2 samples per symbol.

A quadrature channel mixer 60 mixes the received signal r(t) with the quadrature wave signal, e.g., the sine wave sin [ω_{L}(t+δ)], from the local oscillator 52 and gives the quadrature received signal and can be written as

r₃(t)=r(t)sin(ω_{L}t+φ_{L}) (12)

A low pass filter 62 for the quadrature channel removes the component at ω_{c}+ω_{L} in the quadrature received signal. The output signal of the low pass filter 62 is referred to as the quadrature low pass received signal and may be written as 1.

r₄(t)=−½s_{b}(t)sin(Δωt+Δφ)+n_{Q}(t) (13)

where n_{Q}(t) is Gaussian noise process. n₁(t) and n_{Q}(t) are independent identically distributed. An ADC 64 converts the signal r₄(t) to a digital signal r_{Q}[k] at sampling rate Nₛ≧2 samples per symbol.

A signal detector 66 receives the signals from both channels and tries to detect a communications signal s_{b}(t). If the communications signal s_{b}(t) is detected, the signal detector 66 triggers a parameter estimator 67, and a demodulator 74 to demodulate the communications signal s_{b}(t) using outputs 71, 73, 75, 77, discussed in greater detail subsequently. The parameter estimator 67 includes a phase estimator 68 to estimate phase, a timing estimator 70 to estimate timing offset, and a frequency estimator 72 to estimate frequency offset.

Traditional signal detectors need four correlators to perform four correlations for II, IQ, QI and QQ. The invention employs two correlation devices, one for the in-phase channel and the other for the quadrature channel. Comparing against traditional signal detectors, the complexity of the inventive signal detector 66 reduces signal detection complexity by at least 50%. Three signal detector architectures are provided in the following to represent the spirit of the invention.

Signal Detector 1

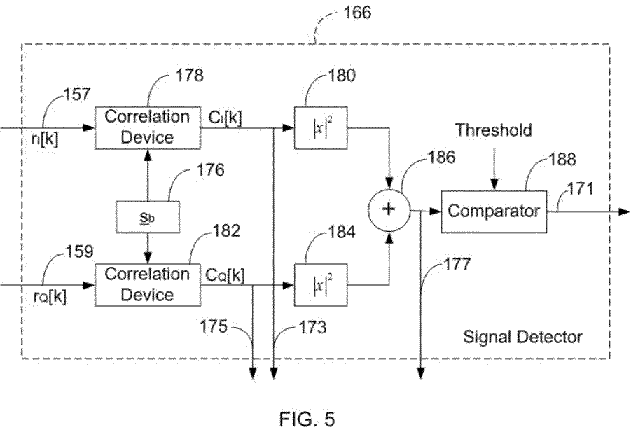

FIG. 5 shows an architecture of one example of the signal detector 66 of FIG. 4. In FIG. 5, wherein like elements have reference numerals offset by 100, a signal detector 166 is shown. An in-phase input port 157 and a quadrature input port 159 receive signals r₁[k] and r_{Q}[k], respectively. A memory device 176 stores s_{b} as the discrete time domain signal of the communication signal s_{b}(t). An in-phase correlation device 178 is electrically connected to the in-phase input port 157 and the memory device 176. The in-phase correlation device 178 receives the digital in-phase signal r₁[k] and the discrete time domain signal s_{b} and computes the correlation between the digital in-phase received signal r₁ and the discrete time domain signal s̅_{b} of the communications signal s_{b}(t). The correlation device output signal C₁[k] is squared by an in-phase squaring device 180. Likewise, a quadrature correlation device 182 is electrically connected to the quadrature input port 159 and the memory device 176 and computes the correlation between the quadrature channel signal r_{Q} and the discrete time domain signal s_{b}. The output signal C_{Q}[k] of the quadrature correlation device 182 is squared by a quadrature squaring device 184. The output signals of the squaring devices 180, 184 are summed together by an adder 186. A comparator 188 compares the output signal of the adder 186 against a preset threshold. An option is to take the square root of the adder output signal, and then compare it against the threshold. When the adder output signal is greater than the threshold, then the signal detector 166 declares the signal has been detected. The signal detector 166 triggers the timing estimator 70 by sending the outputs 171, 177 of the comparator 188 and the adder 186, respectively. The signal detector 166 triggers the phase estimator 68 by sending the outputs 171, 173, 175 of the comparator 188, the first correlation device 178 and the second correlation device 182, respectively. The signal detector 166 triggers the frequency estimator 72 by sending the output 171 of the comparator 188 (the frequency estimator 72 also receives inputs r₁[k] and r_{Q}[k] from the ADCs 58, 64). The signal detector 166 also triggers the demodulator 74 with the output 171 of the comparator 188 (the demodulator 74 also receives inputs from the phase estimator 68, the timing estimator 70, the frequency estimator 72, and inputs r₁[k] and r_{Q}[k] from the ADCs 58, 64). The correlation devices 178, 182 may be either correlators, or matched filters whose impulse response function is h(t)=s_{b}(LT−t), where L is the length of the transmitted signal and T represents symbol time.

In some systems, the noise level changes both spatially and temporally. For such a system, a varying threshold can be employed to maintain a constant probability of false alarm, which is known as constant false alarm rate (CFAR) detection. A typical implementation of CFAR detection is to divide the output of the adder (186 in FIG. 5) by the energy of the received signal, and compare the ratio (or its square root) against a threshold. There are many ways to vary the threshold and achieve CFAR detection.

The phase estimator 68 takes the output signals of the in-phase correlation device 178 and the quadrature correlation device 182 to estimate phase offset. The phase estimator 68 provides a phase estimate as:

$$\hat{φ} = - arc tan \frac{{C}_{Q} [ k ]}{{C}_{I} [ k ]} \qquad ( 14 )$$

where C₁[k] is the output signal of the in-phase correlation device 178 and C_{Q}[k] is the output signal of the quadrature correlation device 182. The phase estimate is employed by the demodulator 74 for demodulation and phase synchronization.

The timing estimator 70 takes the output of the adder 186 and searches for a peak in it. Once a peak is found, the timing estimator employs three values in the adder output signal, they being the peak value, the value right before the peak and the value right after the peak, to perform interpolation and timing offset estimate. The timing offset estimate \hat{δ} is employed to advance or delay the sampling clock and achieve the best time synchronization.

The frequency estimator 72 takes the in-phase channel ADC 58 output signal r₁ and the quadrature channel ADC 64 output signal r_{Q}, performs matched filtering, converts output signals of matched filters to continuous wave (CW) signals, applies discrete Fourier transform (DFT) to the CW signals, and estimates the frequency of CW signals as the frequency offset. The frequency estimator 72 output is an estimate to the frequency offset Δω=ω_{c}−ω_{L}. This estimate is employed by the demodulator 74 for demodulation and frequency synchronization.

Recall the signal s_{b}(t) is L symbols long, and the sampling rate is Nₛ≧2 samples per symbol. The correlation devices 178, 182 need to compute 2NₛL multiplications for every received signal sample. When L is large, the computational complexity can be high.

Signal Detector 2

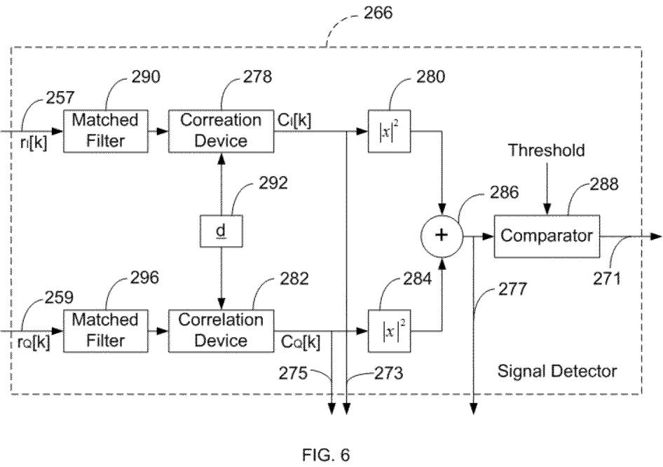

FIG. 6 shows another architecture for the signal detector 266, wherein like elements from this embodiment are offset by one hundred. A filter 290 is matched to the pulse shaping function p(t). The in-phase signal r₁[k], received by the in-phase input port 257, is filtered by the matched filter 290. A memory device 292 stores the sequence d to be detected. A correlation device 278 correlates the matched filter output signal with the sequence d. The output signal C₁[k] of the correlation device 278 is equivalent to the output signal of the correlation device 178 in the signal detector 166 in FIG. 5. A matched filter 296 is matched to the pulse shaping function p(t). The quadrature signal r_{Q}[k], received by the quadrature input port 259 is filtered by the matched filter 296. A correlation device 282 correlates the matched filter output signal with the sequence d. The output signal C_{Q}[k] of the correlation device 282 is equivalent to the output signal of the correlation device 182 in the signal detector 166 in FIG. 5. The remaining parts in the signal detector 266 in FIG. 6 are the same as in the signal detector 166 in FIG. 5.

The in-phase correlation device 278 output signal is squared by the squaring device 280. The output signal of the quadrature correlation device 282 is squared by the squaring device 284. The output signals of squaring devices 280, 284 are summed together by the adder 286. A comparator 288 compares the output signal of the adder against a threshold. An option is to take the square root of the adder output signal, and then compare the square root against a threshold. When the adder output signal is greater than the threshold, the signal detector 266 declares the signal has been detected. The signal detector 266 triggers the timing estimator 70, the phase estimator 68, the frequency estimator 72, and the demodulator 74. The correlation devices 278, 282 may be either correlators or matched filters which can give the same performance.

The phase estimator 68 takes the output signal C₁[k] of the in-phase correlation device 278 and the output signal C_{Q}[k] of the quadrature correlation device 282 to estimate phase offset. The phase estimator 68 provides a phase estimate as defined in Eq. (14). The phase estimate is employed by the demodulator 74 for demodulation and phase synchronization.

The timing estimator 70 takes the output of the adder 286 and searches for a peak in it. Once a peak is found, the timing estimator employs three values in the adder output signal; they being the peak value, the value right before the peak and the value right after the peak, to perform interpolation and timing offset estimate. The timing offset estimate \hat{δ} is employed to advance or delay the sampling clock and achieve the best time synchronization.

The frequency estimator 72 takes the output signal of the matched filter 290 and the output signal of the matched filter 296, converts these signals to CW signals, applies discrete Fourier transform (DFT) to the CW signals, and estimates the frequency of the CW signals as the frequency offset. The frequency estimator 72 output is an estimate to the frequency offset Δω=ω_{c}−ω_{L}. This estimate is employed by the demodulator 74 for demodulation and frequency synchronization.

In this signal detector architecture, 2(Nₛ+L) multiplications are needed to compute correlation for every sample of the received signal.

Signal Detector 3

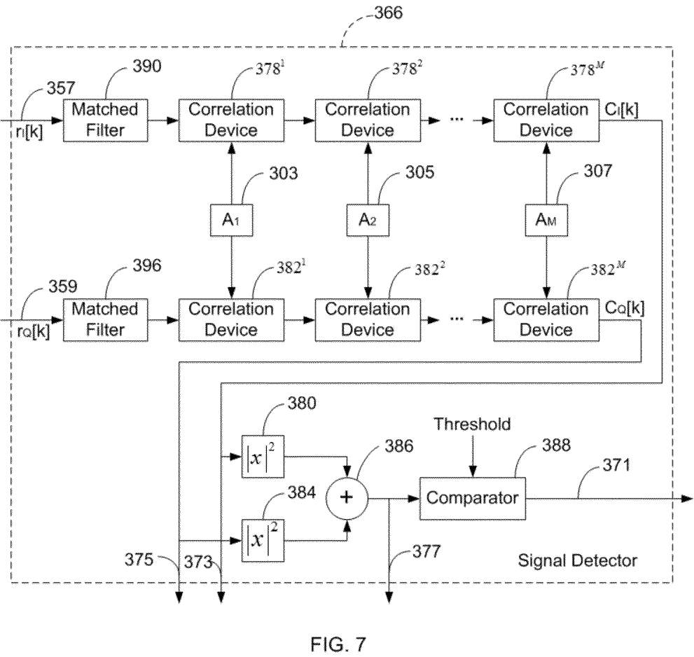

When the signal to be detected is a multiple level signal A₁ [symbol] A₂ [symbol] . . . [symbol] A_{M}, the correlation devices 378¹, 378², 378^{M}, 382¹, 382², 382^{M} and the signal detector 366 have a different architecture, as is shown in FIG. 7 for multiple level signals, wherein like elements from the first signal detector 166 are shown in FIG. 7 offset by 200. The in-phase signal r₁[k] is filtered by the matched filter 390, which is matched to the pulse shaping function p(t). The quadrature signal r_{Q}[k] is filtered by the matched filter 396, which is matched to the pulse shaping function p(t). A memory device 303 stores the component sequence A₁. A correlation device 378¹ computes the correlation between the received in-phase signal and the signal A₁. A memory device 305 stores the component sequence A₂. A correlation device 378² computes the correlation between the correlation device 378¹ output signal and the signal A₂. A memory device 307 stores the component sequence A_{M}. A correlation device 378^{M} computes the correlation between the output signal of the previous correlation device (M−1, not shown) and the signal A_{M}. A correlation device 382¹ computes the correlation between the received quadrature signal r_{Q}[k] and the signal A₁. A correlation device 382² computes the correlation between the correlation device 382¹ output signal and the signal A₂. A correlation device 382^{M} computes the correlation between the output signal of the previous correlation device (M−1, not shown) and the signal A_{M}. The remaining elements in the signal detector in FIG. 7 are the same as in the signal detector in FIG. 5.

The output signal of the in-phase correlation device 378^{M} is squared by the squaring device 380. The output signal of the quadrature correlation device 382^{M} is squared by the squaring device 384. The output signals of squaring devices 380, 384 are summed together by the adder 386. A comparator 388 compares the output signal of the adder against a threshold. When the output signal of the adder 388 is greater than the threshold, the signal detector 366 declares the signal has been detected. The signal detector 366 triggers the timing estimator 70, the phase estimator 68, the frequency estimator 72, and the demodulator 74. The correlation devices 378¹, 378², 378^{M}, 382¹, 382², 382^{M} can be either correlators or matched filters, which can give the same performance.

An option is to take the square root of the adder output signal, and then compare the square root against a threshold.

The phase estimator 68 takes the output signal c[k] of the in-phase correlation device 378^{M} and the output signal C_{Q}[k] of the quadrature correlation device 382^{M} to estimate phase offset. The phase estimator 68 provides a phase estimate as defined in Eq. (14). The phase estimator 68 is employed by the demodulator 74 for demodulation and phase synchronization.

The timing estimator 70 takes the output signal of the adder 386 and searches for a peak in it. Once a peak is found, the timing estimator employs three values in the adder output signal; they being the peak value, the value right before the peak and the value right after the peak, to perform interpolation and timing offset estimate. The timing offset estimate \hat{δ} is employed to advance or delay the sampling clock and achieve the best time synchronization.

The frequency estimator 72 takes the output signal of the in-phase matched filter 390 and the output signal of the quadrature matched filter 396, converts these signals to CW signals, applies discrete Fourier transform (DFT) to the CW signals, and estimates the frequency of the CW signals as the frequency offset. The frequency estimator 72 output is an estimate to the frequency offset Δω=ω_{c}−ω_{L}. This estimate is employed by the demodulator 74 for demodulation and frequency synchronization.

In this signal detector 366, 2(Nₛ+L₁+L₂+ . . . +L_{M}) multiplications are needed to compute correlation for every sample of the received signal, where Lᵢ is the length of the sequence Aᵢ, and

$${\prod }_{i = 1}^{M} {L}_{i} = L .$$

All of the signal detectors 166, 266, 366 described herein work well for communication systems. Both the first signal detector 166 and the second signal detector 266 work for all kinds of signals, including the traditional signals and multiple level signals. When compared against a traditional signal detector using four correlation devices, e.g., correlators, the first signal detector 166 reduces the correlation complexity and multiplication hardware by 50%. Among the three signal detectors 166, 266, 366, the complexity of the first signal detector 166 is the highest because computing correlation sample by sample along the entire signal is great. The complexity of the second signal detector 266 is significantly lower than the complexity of the first signal detector 166.

Being optimized for multiple level signals, the complexity of the third signal detector 366 is the lowest. When the signal length L is large, either the third signal detector 366 or the second signal detector 266 can significantly reduce detection complexity and hardware. It shall be understood that the signal detectors in the present invention can be implemented in many ways while keeping optimal signal detection performance.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

I claim:

1. A receiver (18) for receiving a received signal (r(t)), said receiver (18) comprising:
an input port (51) for receiving the received signal (r(t)), said input port (51) defining first (53) and second (55) branches extending out therefrom allowing the received signal (r(t)) to be transmitted along both of said first (53) and second (55) branches;
an in-phase mixer (54) electrically connected to said first branch (53);
a quadrature mixer (60) electrically connected to said second branch (55);
a local oscillator (52) electrically connected to said in-phase (54) and said quadrature (60) mixers, said local oscillator (52) creating an in-phase wave signal and a quadrature wave phase signal, said in-phase mixer (54) mixing the received signal (r(t)) with the in-phase wave signal to create an in-phase received signal, said quadrature mixer (60) mixing the communications signal with the quadrature wave signal to create a quadrature received signal;
a signal detector operatively connected to said in-phase mixer (54) and said quadrature mixer (60) to receive and correlate the in-phase received signal and the quadrature received signal, said signal detector producing a parameter estimation output and a signal output indicating detection of the received signal (r(t));
a parameter estimator (67) electrically connected to said signal detector (66) and operatively connected to said in-phase mixer (54) and said quadrature mixer (60) for estimating parameters of the received signal (r(t)); and
a demodulator operatively connected to said in-phase mixer (54), said quadrature mixer (60), said signal detector (66) and said parameter estimator (67) to demodulate the received signal (r(t)) for its designated use.

2. A receiver (18) as set forth in claim 1 wherein said parameter estimator (67) includes a phase estimator 68 in electrical communication with said signal detector (66).

3. A receiver (18) as set forth in claim 2 wherein said parameter estimator (67) includes a timing estimator (70) in electrical communication with said signal detector (66).

4. A receiver (18) as set forth in claim 3 wherein said parameter estimator (67) includes a frequency estimator (72) in electrical communication with said signal detector (66) and operatively connected to said in-phase mixer (54) and said quadrature mixer (60).

5. A signal detector for detecting a received signal, said signal detector comprising:
an in-phase input port for receiving an in-phase received signal;
a quadrature input port for receiving a quadrature received signal;
an in-phase correlation device (178) electrically connected to said in-phase input port;
a quadrature correlation devices (182) electrically connected to said quadrature input port;
a memory device electrically connected to said in-phase and said quadrature correlation devices, said memory device storing a key to be supplied to both said in-phase and said quadrature correlation devices as an operand to the in-phase and said quadrature received signals to create an in-phase correlation signal and a quadrature correlation signal, respectively;
an in-phase squaring device for squaring the in-phase correlation signal to generate an in-phase squared signal;
a quadrature squaring device for squaring the quadrature correlation signal to generate a quadrature squared signal;
an adder for adding the in-phase squared signal and the quadrature squared signal to create an added signal; and
a comparator to compare the added signal against a threshold to determine whether the received signal is a communication signal.

6. A signal detector as set forth in claim 5 wherein said memory device stores a discrete time domain signal of the communications signal as the key.

7. A signal detector as set forth in claim 5 wherein said memory device stores a sequence (d) as the key.

8. A signal detector as set forth in claim 7 wherein said signal detector includes an in-phase matched filter electrically connected between said in-phase input port and said in-phase correlation device.

9. A signal detector as set forth in claim 7 wherein said signal detector includes a quadrature matched filter electrically connected between said quadrature input port and said quadrature correlation device.

10. A signal detector as set forth in claim 5 wherein said in-phase and quadrature correlation devices are correlators.

11. A signal detector as set forth in claim 5 wherein said in-phase and quadrature correlation devices are matched filters.

12. A signal detector for detecting a received signal, said signal detector comprising:
an in-phase input port for receiving an in-phase received signal;
a quadrature input port for receiving a quadrature received signal;
a series of in-phase correlation devices (378¹, 378², 378^{M}) operatively connected to said in-phase input port;
a series of quadrature correlation devices (382¹, 382², 382^{M}) operatively connected to said quadrature input port;
a series of memory devices, each electrically connected to each of said series of in-phase and said quadrature correlation devices, each of said memory device storing a single level sequence (A₁, A₂, A_{M}) to be supplied to each of said series of said in-phase and said quadrature correlation devices as an operand to the in-phase and said quadrature received signals to create an in-phase correlation signal and a quadrature correlation signal, respectively;
an in-phase squaring device for squaring the in-phase correlation signal to generate an in-phase squared signal;
a quadrature squaring device for squaring the quadrature correlation signal to generate a quadrature squared signal;
an adder for adding the in-phase squared signal and the quadrature squared signal to create an added signal; and
a comparator to compare the added signal against a threshold to determine whether the received signal is a communication signal.

13. A signal detector as set forth in claim 12 wherein all of said series of in-phase correlation devices are in series with respect to each other.

14. A signal detector as set forth in claim 13 wherein all of said series of quadrature correlation devices are in series with respect to each other.

15. A signal detector as set forth in claim 14 wherein said signal detector includes an in-phase matched filter electrically connected between said in-phase input port and said in-phase correlation device.

16. A signal detector as set forth in claim 15 wherein said signal detector includes a quadrature matched filter electrically connected between said quadrature input port and said quadrature correlation device.

17. A signal detector as set forth in claim 16 wherein each of said series of in-phase and quadrature correlation devices is a correlator.

18. A signal detector as set forth in claim 16 wherein each of said series of in-phase and quadrature correlation devices is a matched filter.

19. A multiple level sequence generator (12) comprising:
a series of sequence generators (20, 22, 24, 26,) for generating sequences (A₁, A₂, A₃, A_{M}); and
a multiple level sequence multiplier (28) for receiving each of the sequences (A₁, A₂, A₃, A_{M}) and multiplying the sequences (A₁, A₂, A₃, A_{M}) together to form a multiple level sequence (A₁ [symbol] A₂ [symbol] . . . [symbol] A_{M}) to be inserted into a communications signal prior to its transmission.

20. A multiple level sequence generator (12′) comprising:
a master clock (38) generating a master clock signal;
a plurality of secondary clocks (40, 42, 44) connected in series with said master clock (38), each of said plurality of secondary clocks (40, 42, 44) operatively driven by said master clock (38) through a series connection with each of said plurality of secondary clocks (40, 42, 44);
a series of sequence generators (20′, 22′, 24′, 26′) for generating sequences (A₁, A₂, A₃, A_{M}) having defined lengths (L₁, L₂, L₃, L_{M}) as an output from each of said series of sequence generators (20′, 22′, 24′, 26′); and
a multiple level sequence multiplier (46) for receiving each of the sequences (A₁, A₂, A₃, A_{M}) as an input to said multiple level sequence multiplier and multiplying the sequences (A₁, A₂, A₃, A_{M}) together to form a multiple level sequence (A₁ [symbol] A₂ [symbol] . . . [symbol] A_{M}) to be inserted into a communications signal prior to its transmission,
wherein said master clock (38) and each of said plurality of secondary clocks (40, 42, 44) generates a clock signal specific to each of said series of sequence generators (20′, 22′, 24′, 26′).

21. A multiple level sequence generator (12′) as set forth in claim 20 wherein said master clock (38) and each of said plurality of secondary clocks (40, 42, 44) are divide-by-length clocks such that said master clock (38) and each of said secondary clocks (40, 42, 44) produce a clock signal specific to the length (L₁, L₂, L₃, L_{M}) of each of said sequences (A₁, A₂, A₃, A_{M}) produced by each of said sequence generators (20′, 22′, 24′, 26′) associated with said master clock (38) and each of said plurality of secondary clocks (40, 42, 44).
